(19) United States
(12) Patent Application Publication
(10) Pub. No.: US 2026/0152921 A1
(43) Pub. Date: Jun. 4, 2026

(54) SYSTEMS AND METHODS FOR MODIFYING A NON-ELECTRIC MACHINE TO BE AN ELECTRIC OR HYBRID ELECTRIC MACHINE

(71) Applicant: Caterpillar Inc., Peoria, IL (US)

(72) Inventors: Jacqueline D. KARL-DEFRAIN, Raleigh, NC (US); Kyle A. MATTHEWS, Metamora, IL (US); Saravanan DURAIARASAN, Peoria, IL (US)

(73) Assignee: Caterpillar Inc., Peoria, IL (US)

(21) Appl. No.: 18/965,196

(22) Filed: Dec. 2, 2024

(51) Int. Cl. E02F 9/20; B62D 65/02; E02F 3/34

(52) U.S. Cl. CPC E02F 9/2075; B62D 65/02; E02F 9/2079; E02F 9/2091; E02F 3/34

(57) ABSTRACT

A communication system for a hybrid electric machine includes: a power source including a genset and one or more batteries; a first control module for controlling a power distribution of the hybrid electric machine; at least a second control module for controlling one of an implement or a transmission of the hybrid electric machine; a first communication line connecting the power source to the first control module; and a second communication line separate from the first communication line connecting the first control module to the second control module.

### TECHNICAL FIELD

The present disclosure relates generally to electric and partially electric machines, and more particularly, to retrofitting a power system of a non-electric machine for use with an electric or partially electric machine.

### BACKGROUND

Industrial vehicles or machines, for example, wheel loaders, excavators, trucks (e.g., dump trucks, haul trucks, articulated dump trucks, etc.), track-type tractors (i.e., bulldozers), graders, continuous miners, feeder breakers, roof bolters, utility vehicles for mining, load-haul-dump (LHD) vehicles, underground mining loaders, underground articulated trucks, etc., may be fully electric, hybrid electric (sometimes referred to as semi-electric or partially electric), and non-electric. Electric and hybrid electric vehicles may include one or more batteries, and non-electric vehicles can be retrofitted or upgraded to include one or more batteries. The one or more batteries include various connections (i.e., electrical connections) to power one or more motors, heating and/or cooling systems, hydraulic system(s), electronics, or auxiliary systems (navigation systems, lighting systems, etc.).

Non-electric vehicles include a controller acting as a supervisor to arbitrate operator requests to the various connections, transmitting and receiving messages indicating that all systems are functioning as intended. Upon retrofitting a non-electric vehicle to include the one or more batteries, an additional controller must be added to satisfy the criteria for normal operation on this controller as well as accommodate the one or more batteries and various electrical components added to the system and to comply with regulatory requirements regarding communications networks between elements of a power control system. There may be significant costs and/or complexities involved in updating the datalinks between the supervisory controller and the various connections to power all control systems of the industrial machine. As such, it would be advantageous to reduce the cost and/or complexity of updating the software and datalinks when retrofitting a non-electric vehicle to include one or more batteries.

The software system and datalinks of the present disclosure may solve one or more of the problems set forth above and/or other problems in the art. The scope of the current disclosure, however, is defined by the attached claims, and not by the ability to solve any specific problem.

### SUMMARY

In one aspect, a communication system for a hybrid electric machine includes: a power source including a genset and one or more batteries; a first control module for controlling a power distribution of the hybrid electric machine; a second control module for controlling one of an implement or a transmission of the hybrid electric machine; a first communication line connecting the power source to the first control module; and a second communication line separate from the first communication line connecting the first control module to the second control module.

In another aspect, a method of retrofitting a non-electric machine into a hybrid electric machine includes: replacing a non-electric power source with a genset and one or more batteries; providing a control module for controlling a power distribution of the genset and the one or more batteries; providing a first communication line between the control module and the genset and the one or more batteries; and providing a second communication line between the control module and existing components of the non-electric machine, wherein the first communication line is isolated from the second communication line, such that the genset does not communicate with the existing components of the non-electric machine.

In yet another aspect, a method of retrofitting a machine includes: removing a non-electric power source from the machine; providing a genset for providing power to existing components of the machine; providing a first control module for controlling a power distribution of the genset; providing a first communication line between the first control module and the genset; and providing a second communication line between the first control module and the existing components of the non-electric machine, wherein the first communication line is isolated from the second communication line.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is an illustration of an exemplary machine, according to aspects of the disclosure.

FIG. 2 is a perspective view of a retrofitted power system of the machine of FIG. 1.

FIG. 3 depicts a schematic diagram of a software system of the retrofitted power system of FIG. 2.

FIG. 4 depicts a flowchart of an exemplary method for retrofitting a non-electric machine into a hybrid electric machine.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

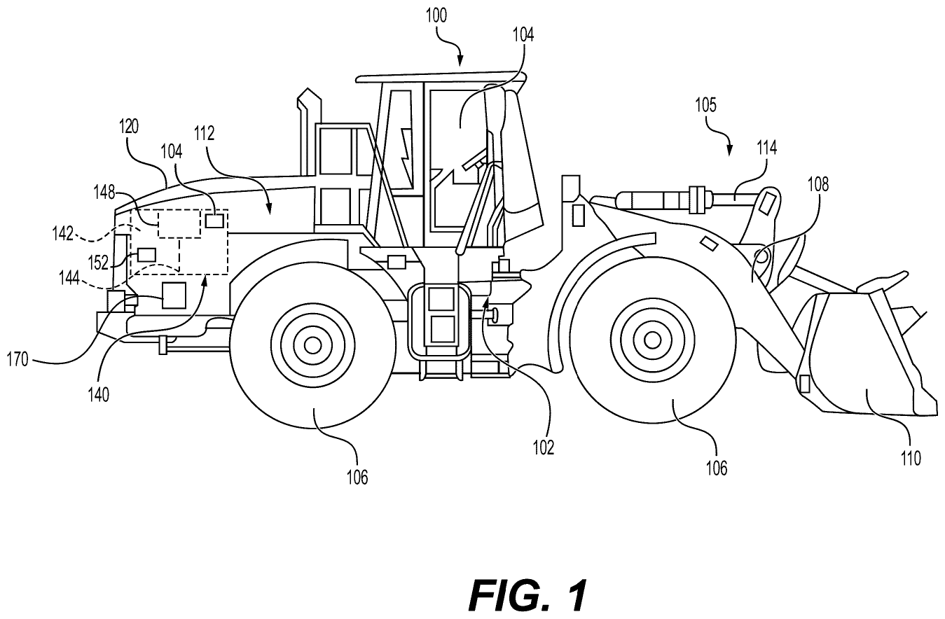

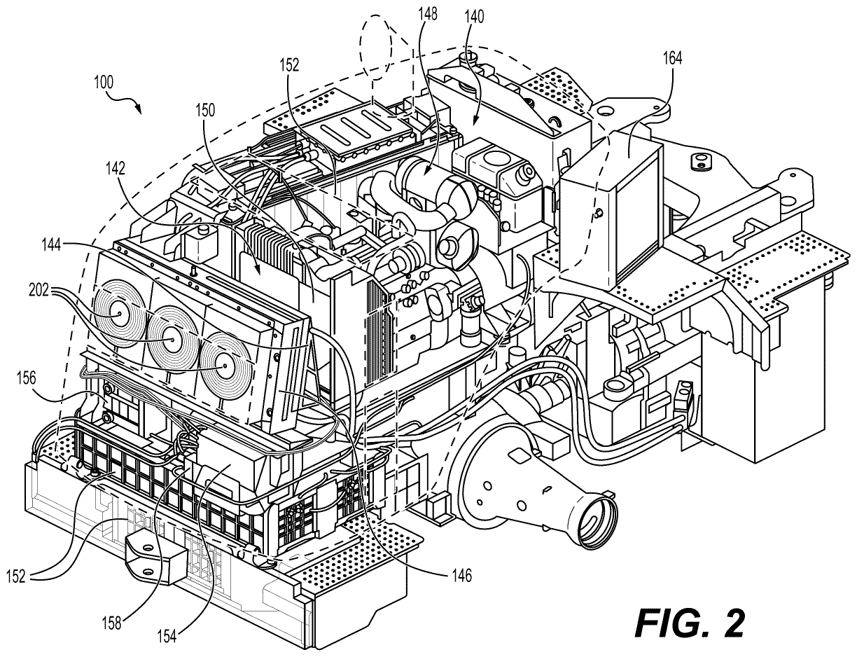

FIG. 1 depicts an exemplary machine 100, for example, a wheel loader. Although machine 100 depicted in FIG. 1 is a wheel loader, machine 100 may be for example, an excavator, a truck (e.g., dump truck, haul truck, articulated dump truck, etc.), a track-type tractor (i.e., bulldozer), a graders, a continuous miner, a feeder breaker, a roof bolter, a utility vehicle for mining, a load-haul-dump (LHD) vehicle, an underground mining loader, an underground articulated truck, etc. Machine 100 includes a machine body 102, which may include an operator station or cab 104. Machine 100 may also include an engine housing, engine bay, or cavity 112 (referred to herein at cavity 112), and a prime mover or power system 140, including one or more rechargeable batteries 152 (FIG. 2). The one or more batteries 152 may power or energize a motor 170 (e.g., to drive wheels 106) and/or other components or systems of machine 100. In some aspects, machine 100 may be fully electric, for example, machine 100 may be fully powered by the one or more batteries 152 of power system 140. Machine 100 may be partially electric (i.e., hybrid), and power system 140 may include a secondary power source, for example, an engine, a genset 148, a fuel cell, etc. The secondary power source may help power or otherwise energize motor 170 to drive wheels 106 and/or power one or more additional components or systems of machine 100. For example, the secondary power source may be used to charge batteries 152 during operation of machine 100. Additionally, in some aspects, the one or more batteries 152 may be removable, for example, to be charged away from machine 100, or to be easily replaced with one or more charged batteries 152 or to serve as a more cost effective option for smaller machine or lower runtime machine. In any of these aspects, charging the one or more batteries 152 or relying on the secondary power source to provide power or otherwise energize various aspects of machine 100 may help to extend the work time of machine 100. In other aspects, the one or more batteries 152 may be charged via a charger (e.g., a plug-in charger) during downtime for machine 100.

Machine 100 may include an implement assembly 105. The implement assembly 105 may include one or more arms 108 and a bucket 110 that may be coupled to an end of arm(s) 108. Although not shown, bucket 110 may also be a different work implement, such as a fork, grapple, etc., and, in some aspects, the work implement may be interchangeable. One or more hydraulic arms (e.g., hydraulic arm 114) may be a part of or otherwise coupled to one or more portions of implement assembly 105 to raise and lower arm 108 and bucket 110, and to tilt bucket 110 toward or away from machine 100. Machine 100 may include ground surface engaging devices, such as wheels 106, which support machine body 12 and are powered by power system 140 including the one or more batteries 152 (e.g., alone or with the secondary power source). In another aspect, machine 100 may instead have tracks (not shown).

Power system 140 including the one or more batteries 152 may be positioned in a rear portion of machine 100. For example, the one or more batteries 152 may be positioned in cavity 112. Machine 100 may include a hood 120 to cover or enclose the one or more batteries 152 within cavity 112. Alternatively, the one or more batteries 152 may be positioned anywhere on machine 100.

A supervisory electronic control module (“ECM”) 104 may control operation of one or more aspects of power system 140. In some aspects, supervisory ECM 104 controls operation of all aspects of power system 140. Supervisory ECM 104 may be in communication with one or more features or portions of machine 100. Supervisory ECM 104, and other electronic control modules disclosed herein, may receive inputs and send outputs, for example, in order to operate machine 100, including initiating one or more indications or warnings on an information display 30, energizing the secondary power source, controlling the power distribution unit, monitoring the state of charge and the batteries, etc. Although not shown, supervisory ECM 104 may be coupled to or include one or more memory units, which may contain instructions for supervisory ECM 104 to initiate one or more displays or one or more precautionary steps or procedures. Supervisory ECM 104 may be a separate controller on machine 100, or may be integrated into a central vehicle controller (e.g., a main power or operation controller, etc.). Alternatively, supervisory ECM 104 may be integrated into one or more of a battery management system, a motor control module, or another dedicated control module on machine 100. In one aspect, machine 100 may be an electrohydraulic wheel loader, and supervisory ECM 104 may control one or more electrical switches or valves in order to control one or more hydraulic cylinders or electrical elements in order to operate machine 100.

Supervisory ECM 104 may embody a single microprocessor or multiple microprocessors that may include systems for performing any of the operations mentioned herein. For example, supervisory ECM 104 may include a memory, a secondary storage device, a processor, such as a central processing unit or any other systems for accomplishing a task consistent with the present disclosure. The memory or secondary storage device associated with supervisory ECM 104 may be non-transitory computer-readable media that store data and/or software routines that may assist supervisory ECM 104 in performing its functions, as discussed below. Further, the memory or secondary storage device associated with supervisory ECM 104 may also store data received from the various inputs or sensors associated with machine 100. Numerous commercially available microprocessors can be configured to perform the functions of supervisory ECM 104. Various other known circuits may be associated with supervisory ECM 104, including signal-conditioning circuitry, communication circuitry, hydraulic or other actuation circuitry, and other appropriate circuitry. As discussed herein, supervisory ECM 104 may receive various inputs (e.g., from various sensors or user inputs), and based on the various inputs, supervisory ECM 104 may initiate one or more indications or warnings on an information display, energize the secondary power source, control the power distribution unit, and monitor the state of charge and the batteries, etc.

As shown in FIG. 2, power system 140 may include a secondary power source, for example, a genset 148. Genset 148 may include or otherwise be coupled to a radiator 150. Genset 148 and radiator 150 may be positioned within the front portion of cavity 112. Radiator 150 may be positioned to the rear of the genset 148. Genset 148 may be diesel powered, gasoline powered, etc. Although the secondary power source is discussed as genset 148, in other aspects, secondary power source may be a hydrogen powered engine, a fuel cell, etc. Power system 140 may further include a power electronics module 146. Power electronics module 146 may be positioned within the rear portion of cavity 112. For example, a central chamber 142 and/or a divider 144 (e.g., a thermally or air-flow insulating shroud) may be positioned between (e.g., along a longitudinal axis of machine 100) genset 148 and power electronic module 146. In these aspects, central chamber 142 and divider 144 may be positioned between (e.g., along a longitudinal axis of machine 100) radiator 150 and power electronics module 146.

Genset 148 may include an internal combustion engine that produces mechanical and/or electrical power output. For example, genset 148 may include a four-stroke diesel engine. Genset 148 may include one or more subsystems, for example, a fuel system, an air induction system, an exhaust system (coupled to an after-treatment system), a lubrication system, a cooling system, and/or the like. Genset 148 may be configured to produce a torque output directed to a transmission and/or to other parasitic loads (e.g., to hydraulic systems, electrical systems, cooling systems, etc.) through a range of speeds.

Power system 140 may include a battery thermal management system (“BTMS” 164) to help regulate the temperature of the one or more batteries 152, for example, to help prevent deterioration or improve performance. BTMS 164 may be positioned within or outside cavity 112. For example, BTMS 164 may be positioned within the front portion of cavity 112 or adjacent to the front portion.

Power system 140 may further include a power distribution unit (PDU 154), a DC-DC converter 156, an AC-DC inverter 158, a gearbox 160, and an on-board charging station (e.g., charger 162). PDU 154, converter 156, and inverter 158 may be positioned within the rear portion of the cavity 112 and/or below power electronics module 146. PDU receives and distributes energy from the batteries and secondary power source to the motor and other components of the machine 100. Charger 162 may be positioned to the rear of central chamber 142 below and/or within the rear portion of the cavity 112. Gearbox 160 may be positioned within the front portion of the cavity 112.

The one or more batteries 152 of power system 140 may be positioned within cavity 112. For example, the one or more batteries 152 may include three batteries 152. One or more of the batteries 152 may be positioned within the front portion of the cavity 112. For example, one or more of batteries 152 may be adjacent to genset 148. Further, one or more of batteries 152 may be positioned within the rear portion of the cavity 112. For example, one or more batteries 152 may be positioned under one or more of power electronics module 146, PDU 154, converter 156, and inverter 158. The one or more batteries 152 may be lithium ion phosphate batteries, however, the one or more batteries 152 may be any type of battery for powering electric or partially electric vehicles or machines. Each of the one or more batteries 152 may include a plurality of battery cells (e.g., a battery pack or a battery string).

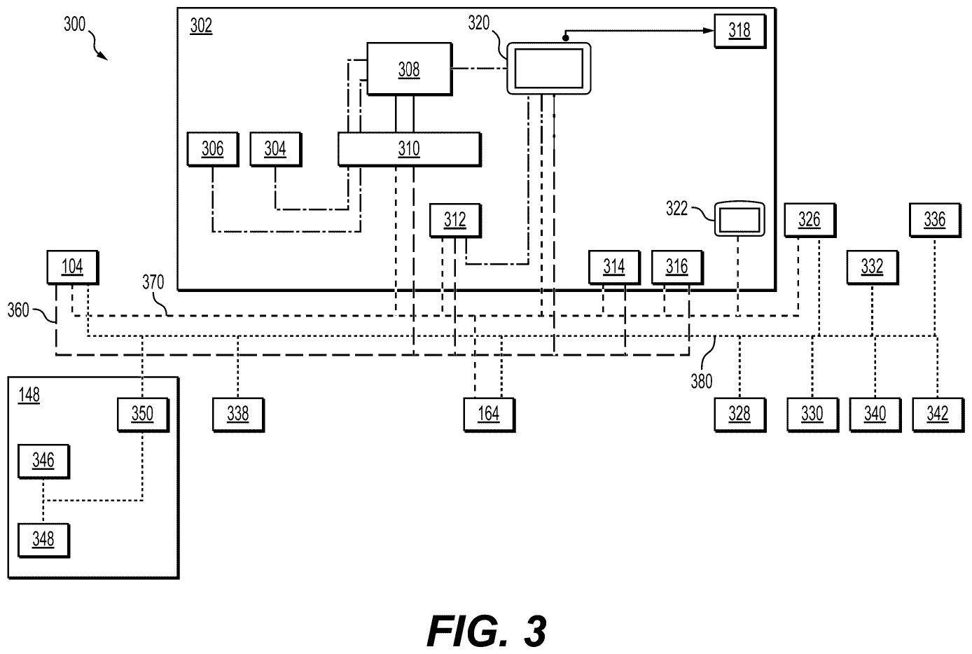

FIG. 3 depicts a schematic diagram of a retrofitted communication system 300, where the system 300 is for use with a machine retrofitted to be at least partially electric. Existing components 302 are components usable with a non-electric machine that are preserved when retrofitting the non-electric machine to be an electric machine or partially electric machine. These components include one or more of: a first communications module 304 for linking to satellite or cellular data, a radio communications module 306, a network management ECM 308 for controlling network communications, a connector 310 for connecting to communication lines, such as a controller area network (“CAN”) line, a second connector 312 for connecting CAN lines to information displays, an implement ECM 314 for providing electronic controls to implement assembly 14, a transmission ECM 316 for providing electronic controls to a machine transmission (not shown), an imaging device 318 (e.g., a camera), an information display 320 for providing one or more messages and alerts to an operator, and an indication display 322 for providing measurements and readings from sensors and gauges, etc. (not shown).

New components upon a retrofit include one or more of supervisory ECM 104, discussed above, the one or more batteries 152, BTMS 164, a user input device 328, such as a keyboard or other user input or interface device, which in some embodiments may have been part of existing components 302, a power electronic module for modifying electrical output of the first power source 330, one or more high power chargers 332, a battery management system 334, a ground fault device 336, a second power electronic module for modifying electrical output of the second power source 338, a first low-voltage implement 340, a second low-voltage implement 342, a CAN repeater 350, and genset 148, which includes a pre-packaged power source assembly 348 including the secondary power source, and a dedicated secondary power source control module 346. In some examples, first and second low-voltage implements includes fans for a cooling system, such as fans 202 in FIG. 2.

Existing components 302, as part of a non-electric machine, are configured to send and receive one or more messages from an engine controller module of the non-electric machine. Upon retrofitting the non-electric machine into an electric or partially electric (hybrid) machine, supervisory ECM 104 may be configured to mimic the engine controller module of the non-electric machine to obviate the need for reconfiguration and updating of the format and syntax of the one or more messages sent and received by existing components 302.

Supervisory ECM 104 may be connected to the existing components 302 via a first CAN 360. First CAN 360 may be configured to be identical to an existing data link on a non-electric vehicle before the retrofit, and to only communicate with the non-electric previous supervisory ECM 104 and existing components 302. In particular, implement ECM 314 and transmission ECM 316 communicate with supervisory ECM via first CAN 360 and do not communicate with genset 148 via any of first CAN 360, a second CAN 370, or a third CAN 380. Implement ECM 314 and transmission ECM 316 communicate with supervisory ECM 104 to control vital aspects of the operation of machine 100.

Second CAN 370 allows for supervisory ECM 104 to communicate further with the existing components 302 and also to communicate with user input device 328, BTMS 164, and a battery management system (“BMS”) 326. BTMS 164 and BMS 326 may be incorporated into the existing components 302 without interfering with existing communications. As such, their isolation from the existing components 302 is not necessary. User input device 328, in some embodiments, can be an existing component of the non-electric machine. Even where the user input device 328 is a new component, it likewise does not interfere with the existing communications.

Third CAN 380 is configured to communicate with BTMS 164 and BMS 326, and also with components that are required to be isolated from existing components 302. Third CAN 380 communicates with genset 148 via CAN repeater 350, and further communicates with first inverter 330, high power chargers 332, ground fault device 336, second inverter 338, first low-voltage power electronic module 340, and second low-voltage power electronic module 342. CAN repeater 350 isolates genset 148, allowing for a lower load on the communication bus.

First CAN 360 is thus isolated from second CAN 370 and third CAN 380 and other components of retrofitted communication system 300, in particular genset 148. Supervisory ECM 104 may be configured to receive and send the same message(s) in a same format and same syntax as an engine controller module of a non-electric vehicle, and to otherwise mimic the engine controller module of the non-electric machine in communications with existing components 302.

### INDUSTRIAL APPLICABILITY

The disclosed aspects of the communication system 300 of the present disclosure may be applied to any electric or partially electric machine or vehicle, such as a wheel loader retrofitted from a non-electric wheel loader to an electric or partially electric wheel loader. During a retrofit, many existing components 302 of a non-electric machine may be carried over to be used in an electric or partially electric machine.

As discussed above, the communication system 300 includes communication lines, CAN 360, CAN 370, and CAN 380, along with supervisory ECM 104 that are configured to allow for the existing components 302 of a non-electric machine to be adapted to and included in the electric or partially electric machine without a need to reconfigure the software or hardware associated with the existing components 302. Thus, the communication system 300 allows for convenient, efficient, and cost-effective retrofitting of existing non-electric machines to electric or partially electric machines.

Retrofitting existing non-electric machines to electric or partially electric machines provides ecological and environmental benefits, increases fuel efficiency, and increases the expected useful life of existing machines, which potentially would have otherwise been required to be retired or scrapped if retrofitting proved too costly.

The disclosed communication system 300 may be implemented in existing and future machines. In particular, the disclosed communication system may be implemented in existing machines (e.g., in a retrofitting procedure) that have been converted from fuel-burning machines to at least partially electric machines without regard to the type of fuel burned by an engine of the machine or the genset.

The disclosed communication system 300 further allows communication for existing components and new components of a retrofitted machine over separate networks, maintaining existing communication networks for the existing components to simply modification. Furthermore, the existing communication networks, such as first CAN 360, allow for mimicking signals (e.g., motor speed mimicking engine speed), incorporating and addressing existing message syntax and format. Furthermore, implement ECM 314 and transmission ECM 316 require no new software to communicate with a new supervisory ECM 104. The communication system 300 allows for a secondary power source control module 346 to be on a separate CAN from transmission ECM 316.

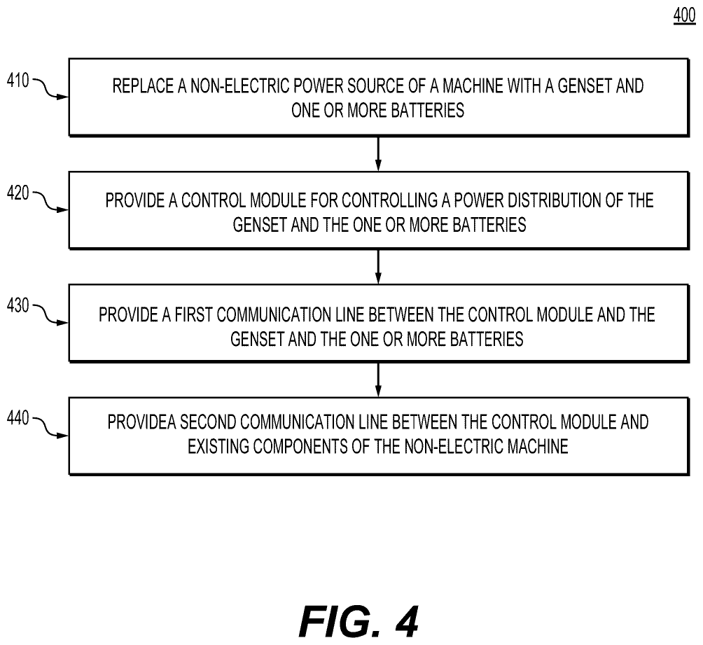

As shown in FIG. 4, a method 400 of retrofitting a non-electric machine into a hybrid electric machine may include the following steps. At step 410, the method 400 may include replacing a non-electric power source (e.g., a large diesel engine) of a machine with a genset and one or more batteries. At step 420, the method may include providing a control module for controlling a power distribution of the genset and the one or more batteries. The control module may be configured to mimic an engine controller of a non-electric machine. For example, the control module may be configured to send and receive the same message(s) as the engine controller of the non-electric machine. At step 430, the method may include providing a first communication line (e.g., CAN 380) between the control module and the genset and the one or more batteries. At step 440, the method may include providing a second communication line (e.g., CAN 360) between the control module and existing components of the non-electric machine, wherein the first communication line is isolated from the second communication line, such that the genset does not communicate with the existing components of the non-electric machine.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A communication system for a hybrid electric machine, comprising:
a power source including a genset and one or more batteries;
a first control module for controlling a power distribution of the hybrid electric machine;
a second control module for controlling one of an implement or a transmission of the hybrid electric machine;
a first communication line connecting the power source to the first control module; and
a second communication line separate from the first communication line connecting the first control module to the second control module.

2. The communication system of claim 1, wherein the first communication line is isolated from the second communication line, such that the genset does not communicate with the second control module.

3. The communication system of claim 1, wherein the first control module is configured to mimic an engine controller of a non-electric machine.

4. The communication system of claim 3, wherein the second control module comprises a component of the non-electric machine.

5. The communication system of claim 4, wherein the second control module controls the implement of the hybrid electric machine, wherein the machine is a wheel loader and the implement is a bucket.

6. The communication system of claim 4, wherein the second control module controls the transmission of the hybrid electric machine, and wherein the transmission of the hybrid electric machine is unchanged from a transmission of the non-electric machine.

7. The communication system of claim 3, wherein the first control module is configured to send and receive a same one or more messages as the engine controller of the non-electric machine.

8. The communication system of claim 1, further comprising a battery management system and a third communication line, wherein the third communication line is configured to communicate between the first control module and the battery management system.

9. A method of retrofitting a non-electric machine into a hybrid electric machine, the method comprising:
replacing a non-electric power source with a genset and one or more batteries;
providing a control module for controlling a power distribution of the genset and the one or more batteries;
providing a first communication line between the control module and the genset and the one or more batteries; and
providing a second communication line between the control module and existing components of the non-electric machine, wherein the first communication line is isolated from the second communication line, such that the genset does not communicate with the existing components of the non-electric machine.

10. The method of claim 9, further comprising:
configuring the control module to mimic an engine controller of the non-electric machine.

11. The method of claim 10, further comprising:
configuring the control module to send and receive a same messages as the engine controller of the non-electric machine.

12. The method of claim 10, wherein the control module is a first control module, and wherein the existing components of the non-electric machine includes a second control module for controlling one of an implement or a transmission of the hybrid electric machine.

13. The method of claim 12, wherein the second control module is an existing component of the non-electric machine.

14. The method of claim 12, wherein the second control module controls an implement of the hybrid electric machine, and wherein the hybrid electric machine is a wheel loader and the implement is a bucket.

15. The method of claim 12, wherein the second control module controls a transmission of the hybrid electric machine, and wherein the transmission of the hybrid electric machine is unchanged from the transmission of the non-electric machine.

16. The method of claim 9, wherein the control module is configured to send and receive a same one or more messages as an engine controller of the non-electric machine.

17. The method of claim 9, further comprising:
providing a third communication line configured to communicate between the control module and a battery management system.

18. A method of retrofitting a machine, the method comprising:
removing a non-electric power source from the machine;
providing a genset for providing power to existing components of the machine;
providing a first control module for controlling a power distribution of the genset;
providing a first communication line between the first control module and the genset; and
providing a second communication line between the first control module and the existing components of the non-electric machine, wherein the first communication line is isolated from the second communication line.

19. The method of claim 18, further comprising:
configuring the first control module to send and receive a same messages as an engine controller of the non-electric machine.

20. The method of claim 18, wherein the first control module is configured to send and receive a same one or more messages as an engine controller of the non-electric machine.
